(19) United States
(12) Patent Application Publication
(10) Pub. No.: US 2016/0209900 A1
(43) Pub. Date: Jul. 21, 2016

(54) Power Optimization of Computations in Digital Systems

(71) Applicants: Ilya Blayvas, Jerusalem (IL); Ron Fridental, Shoham (IL)

(72) Inventors: Ilya Blayvas, Jerusalem (IL); Ron Fridental, Shoham (IL)

(21) Appl. No.: 14/600,057

(22) Filed: Jan. 20, 2015

(51) Int. Cl. G06F 1/28; G06F 1/32

(52) U.S. Cl. CPC G06F 1/28; G06F 1/3228

(57) ABSTRACT

The novel architecture for digital signal processing systems, comprising a number of blocks with means for power measurement is disclosed. The energy of execution of the software on the said system is evaluated as integral of execution power over time. The method of energy profiling of software is disclosed that reveals in which tasks of the software, and in which blocks of the hardware and what amount of energy is spent in the execution. The novel energy optimization methods in software development, compilation, debugging, profiling, optimization, execution, updating and hardware development are disclosed.

### CROSS REFERENCE TO RELATED APPLICATIONS

None

### STATEMENT REGARDING FEDERALLY SPONSORED RESEARCH OR DEVELOPMENT

Not Applicable.

### REFERENCE TO SEQUENCE LISTING

Nor Applicable.

### REFERENCES CITED

US PATENTS

| | | | |
|---|---|---|---|
| 2,981,877 | July 1959 | Noyce | 257/587 |
| 3,029,366 | April 1959 | Lehovec | 257/544 |
| 8,275,560 | September 2012 | Radhakrishnan et. al | 702/60 |
| 8,650,423 | February 2014 | Li et. al | 713/322 |

### OTHER REFERENCES CITED

[B1] Rabaey et. al. Digital Integrated circuits. Prentice Hall 2003, ISBN 0-13-090-996-3;
[B2] Youngsoo Shin et. al. Power Gating: Circuits, Design Methodologies and Best Practice for Standard-Cell VLSI Designs. ACM Transactions on Design Automation of Electronic Systems, Vol 15, September 2010.

### POWER OPTIMIZATION OF COMPUTATIONS IN DIGITAL SYSTEMS

### Technical Field

The present disclosure relates to the field of digital signal processing in general, and to the power saving in digital integrated circuits in particular.

### Background And Introduction

Humanity enjoys the fruits of digital signal processing revolution [A1, A2], when several decades of exponential growth in integration density and processing speed resulted in creation of handheld devices capable to perform many billions operations per second.

Traditionally, the primary measure of performance of digital systems was processing power, measured in number of operations per second. However with rising prices for energy sources, concerns about environment, and rising part of the digital systems in power consumption, power saving in computations becomes increasingly important.

Power efficiency of computations is even more important the systems, where size, weight and power supply are critical, since decrease of power consumption in digital part results in decrease in the cooling systems resulting in even more significant decrease of the size, weight, price and overall power consumption, allowing cheaper, smaller and more reliable systems with significant advantages in manufacturing and maintenance

Finally, in the domain of battery-powered systems, such as smartphones, tablets, digital cameras, netbooks, laptops etc. the energy efficient computations are of crucial importance, since they allow longer operation before battery recharging, which is a crucial figure of merit for such system.

A lot of effort had been invested in the efforts to decrease the power consumption in the digital systems. They included dynamic change of the clock rate, and voltage of the processing cores, and switching off of the idle subsystems by clock gating and power gating [A3, A4], [B1, B2].

Although significant success had been shown in these approaches, much more can be and need to be done in this field. The prior art approaches to power reduction stayed within the conventional paradigm, where the figure of merit for the hardware performance was the processing power, and the figure of merit for the program was its runtime.

In modern handheld systems the processing power is often present in excess of what is needed, and it becomes even more excessive with every new generation of the systems. However this processing power can't be used for any prolonged time due to unacceptable buttery drain. Therefore, it is the energy consumed during the program execution, rather than its runtime had become of crucial importance, and it is the processing power of the hardware relative to the consumed electric power rather than a bare processing power became the primary figure of merit for the hardware.

Unfortunately, in the prior art systems and software development environments, the power consumption of the system is unknown and invisible to the programmer and to the program, neither at the time of development nor at the time of execution. Similarly in the hardware development the power consumption of the circuit is unknown to the designer.

It is the purpose of the present disclosure to describe the methods and apparatus for measurement of the power consumption for software execution, and use of these measurements for software design, development, optimization, compilation, and execution, as well as for the hardware analysis, optimization and design.

### BRIEF SUMMARY

In the modern digital electronic systems, such as, for example, smartphones, much of the digital signal processing hardware is concentrated in the system-on-chip, which is often referred to as application processor. These application processors usually comprise several processing cores. Moreover, Heterogeneous System Architecture, when the application processor comprises several processing cores of different architecture becomes widespread.

A typical system may comprise a number of stronger generic CPU cores; a number of weaker, low power generic CPU cores; a vector processing unit of SIMD (single instruction, multiple data) architecture; a GPU (graphics processing unit). This digital architecture is often referred to as Heterogeneous System Architecture (HSA), meaning that the application processor comprises a set of different, non-equivalent cores (heterogeneous system), distinguishing it to from the earlier architecture solution, when the system comprised a number of identical processing cores (homogeneous system).

Usually the different parts of the software running on the system with HSA are executed on corresponding different cores: Operating system and generic code is executed on powerful or power-saving CPU cores; image and video processing code on the vector processing unit, computer graphics is generated on the GPU core etc.

The binding of specific part of the code to a particular processing core is usually decided in advance at the early stages of software development, with the notable exception for alternating between the powerful, and power-saving CPU cores.

Yet, the capabilities of the processing cores allow to execute at least some parts of the code on different cores. For example, parts of image, signal, data processing, calculations, generation of graphics, can be performed on either generic CPU cores, vector processing unit, Graphic Processing Unit or other processing units and other processing units of the system.

Conventionally, the assignment of the software part for execution on a specific hardware core was done on the merits of computational speed. The core that executed the given part of the software with the fastest speed, was the prime candidate for its execution. However, for the systems where the battery charge rather than the computational speed becomes the primary figure of merit, the assignment based solely on the execution speed may become suboptimal in terms of battery life.

Consider the case, when running a specific software task on low-power core B takes twice the time of running on fast core A, but at the same time the low-power core consumes only quarter of the power. This results in the task being performed on core B in twice the time but only half the energy of performing the same task on core A. However in the prior art computing systems, the programmer could only measure the execution speed of the program, but remained clueless about the consumed power. Therefore, any effort of power optimization of the software was comparable to the wandering for the good way in a complete darkness, and even without sense of touch.

One of the inventions disclosed here is the methods and apparatus for measurement of the power consumption by a computational core or its blocks. Another invention presented in this disclosure is the method of assignment of the computational tasks to execution on specific processing cores based on considerations of minimization of the energy, spent for the execution.

We envision the new approach to hardware design and optimization, governed by considerations of energy consumption during execution of a given task, and we disclose novel hardware solutions and methods enabling that approach.

Furthermore, we envision the new paradigm of development and execution of the software, where the considerations of energy minimization will guide all the chain of software development and execution, from conceiving and design of software architecture, towards implementation, debugging, profiling and optimization of the software, compilation, execution and updating. Here we disclose a number of methods and architecture solutions, enabling this new paradigm.

The prior art computational systems lack the means for evaluation of energy or power spent by computational unit during an execution. Therefore, we disclose here a number of methods, and hardware structures for evaluation of power and energy spent during computation. The disclosed methods can provide high accuracy, and resolution in both time and space—allowing accurate measurement of power spent during execution of certain tasks and commands, and in certain computational cores and blocks.

### BRIEF DESCRIPTION OF THE DRAWINGS

The following drawings are presented for illustrating of the disclosure. Unless indicated otherwise, the drawings provide exemplary embodiments or aspects of the disclosure and do not limit its scope. In the drawings:

FIG. 1 is a schematic drawing of an application processor with means for power measurement.

FIG. 2 is a schematic drawing of one of the embodiments of power measurement circuitry.

FIG. 3 is a schematic drawing of power measurement circuitry switching between several different blocks.

FIG. 4 is a flowchart of software design for power minimization.

FIG. 5 is a flowchart of software compilation with power optimization by selection of alternative sets of commands.

FIG. 6 is a flowchart of software compilation and power profiling for different alternative cores.

FIG. 7 is a flowchart of software execution, with power profiling and adaptive selection of dynamically linked libraries.

FIG. 8 is a schematic flowchart illustrating the procedures of hardware power profiling, analysis, optimization and design.

FIG. 9 is a schematic illustration of using the representative points for evaluation of power consumption by the computational blocks.

FIG. 10 is a flowchart illustrates the energy profiling of the software during its execution on the hardware with power measurement capabilities.

FIG. 11 is a schematic drawing of power consumption evaluation for the power-gated cells.

### DETAILED DESCRIPTION

This disclosure relates to the power saving in digital integrated circuits. Their applications are vast, spreading in all the industries and markets where digital or mixed signal integrated circuits exist.

Sometimes the terms power minimization and energy minimization will be used interchangeably. Energy is defined as power integrated over time. Yet, we sometimes afford using the term power minimization, relating to the fact that if the digital system performs given number of tasks per specific period of time, and if energy of execution of the tasks decreased, than the average power consumption of the system during their execution had decreased too.

For the sake of conciseness and clarity, we will start with a handheld smartphone as an example of electronic system, and it's Application Processor as a core integrated circuit, which is a system on the chip, comprising several subsystems. However the disclosure is applicable to any electronic system comprising any set of the integrated circuits for digital or mixed signal processing.

We consider the power measurement and optimization on the level of computational core, however the disclosed methods and solutions are applicable without limitation at all other the levels of hierarchy.

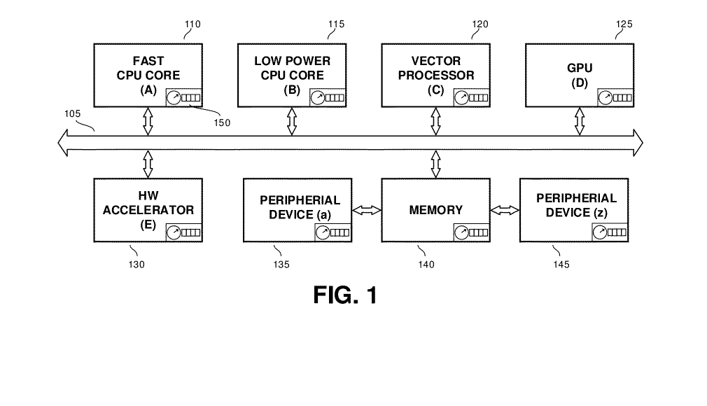

Consider a digital system schematically drawn of the FIG. 1. The system comprises a bus 105; processing cores 110, 115, 120, 125, 130; memory 140 and peripheral devices 135 and 145.

The bus may be further divided into data, address and control buses, which is not shown on the figure. The processing cores may comprise one or more fast CPU cores 110, one or more low-power CPU cores 115, vector processor of the SIMD (Single Instruction, Multiple Data) type 120, GPU (Graphic Processing Unit) 125, one or several Hardware Accelerator units 130, system memory 140 and one or several peripheral devices 135, 145. The hardware accelerator 130 may comprise any circuit, performing some processing operations which may be used in some of the computations of the system, such as video, sound, graphic processing etc.

Some of the processing blocks may comprise the means for power measurement 150. It may allow measuring the power consumed by the block during the calculations, which allows improvements in power efficiency of software and hardware: choosing the most power efficient block for executing any specific task, choosing the most power efficient algorithm, optimization of the software compilation, energy profiling of the program, optimization of the next generation of hardware for power efficient designs.

The names and specialization of computational blocks are given as a non-limiting examples. The disclosed solutions may be applied to other processing cores, or other blocks within the system, at any level of hierarchy—from the complete systems, to the smallest sub-circuits within the systems.

The disclosed methods are illustrated by power measurement via evaluation of the voltage drop across the lines and/or power gates. The voltage drop is evaluated by Analog to digital (A/D) converters.

However the present disclosure is not limited to any particular means of power measurement. Other examples may include power measurement via measuring the frequency of ring oscillator, which may be calibrated to take into account variations of the temperature, process and voltage supply. The power measurement means may also include one or more temperature sensors calibrated to relate between the temperature measurements across the chip to the power dissipated in the system or its subsystems.

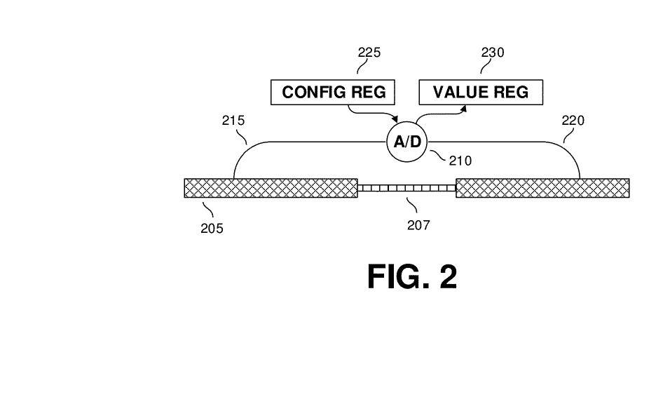

FIG. 2 illustrates one of the embodiments of the means for power measurement. 205 is power line towards the processing core, processing block, unit or any other digital, or mixed signal circuit, system, or subsystem. 205 may be a Vdd or Vss line, providing positive, negative voltage or ground. It may be a sole power line or a part of a power grid.

Analog to digital converter (A/D) is connected to the line 205 via the sampling lines 215 and 220 and measures the voltage drop along the corresponding interval of the line 205. To increase the voltage drop, optional resistive section 207 may be embedded into the line 205. Also optional element such as one or more power gating transistors, via holes, transitions to other metal layers, or other elements may be embedded between the measurement points.

The operation range of the A/D converter may be from the order of several millivolts to the order of several tens of volts, more commonly, however, it will be in the range from +/−0.5 Volt, up to +/−12 Volt. In some embodiments the A/D rage will essentially coincide with voltage supply range of the integrated circuit, or its part, where the A/D operates.

The number of resolution bits of A/D may be from 8 to 24 bit, but usually will be in the range of 10 to 16 bits. The sampling speed of A/D can be anywhere in the range from 10̂3 to 10̂12 samples per second, but usually will be in the range of 10̂5 to 10̂9 measurements per second.

The current flowing along the line 205 produces a voltage drop due to the resistivity of the line 205 and other optional elements within it. The voltage drop value measured by A/D may be transferred and stored in the register 230. A/D may be controlled by an optional control register 225. The registers 230 and 225 may be mapped into the memory, connected to the system bus or accessed by any other way, known in the art.

The measured voltage drop dV is related to the consumed power P via the formula P=V*I, where V is the supply voltage, I is the consumed current evaluated via I=dV/R, where R is the resistance of the line between the voltage sampling points.

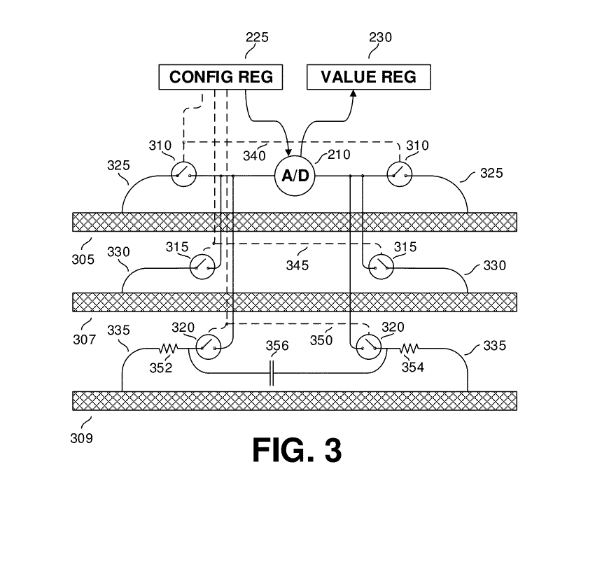

FIG. 3 illustrates an optional configuration of the power switch, where the single A/D converter 210 can be connected to two or more different power lines. For example the connection towards the line 305 is facilitated by switching on the switches 310 and switching off the switches 315 and 320, while the connection towards the line 307 is facilitated by switching on the switches 315 and switching off the switches 310 and 320.

The switches may be controlled from configuration register 225 via the control lines 340, 345, 350. This configuration allows to monitor power consumption in multiple points by a single A/D converter, saving the area, price and power consumption in A/D converters, and increasing the number of monitored cells and resolution in the sub-circuit hierarchy.

The power consumption may vary significantly even over short periods time, alternating even between adjacent clocks. To improve accuracy of power measurement, and reduce the noise during the A/D sampling by signal averaging, the low pass filters may be used. For example resistors 352, 354 and capacitor 356 provide the time averaging of the voltage drop measured on the line 309. The resistance and capacitance values R, C of the elements are set to provide time constants corresponding to the sampling rate v, RC=I/v.

For example, if the A/D is designed to take v samples per second, and it switchable between N different points, the RC filter should have the characteristic integration time of about N/v microseconds, which may be accomplished by resistance R and capacitance C values corresponding to RC≈N/v. The simple filter of RC type is given as a non-limiting example, any other architecture of low-pass filter may be used.

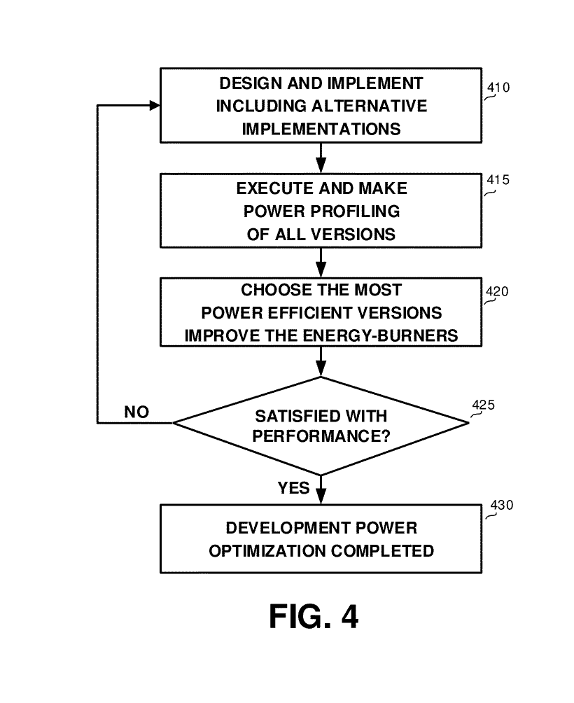

FIG. 4 is a flow chart of the design of power efficient software. 410 is the stage of the design and coding of the software. In the case when the same software block can be implemented in several ways, or developed for two or more different processing cores, the engineer can design and implement several possible variants in order to compare their power performance in stage 415. Power profiling is the procedure of tagging of software blocks, its procedures and commands with the ‘energy tag’—indicating the measured energy for their execution. Energy for execution of a block is the consumed electrical power integrated over execution time.

Power profiling helps understanding the way of power consumption by various parts of software in their execution on various parts of hardware. The results of power profiling allow to choose the most efficient software solutions in 420, run and compile the software blocks on the most appropriate computation cores, localize and improve the power-burners—the parts of the software wasting the most of the electric power for their computation.

If the results are judged as not satisfying in 425, the design procedure repeated iteratively from 410, otherwise the power optimization is completed in 430.

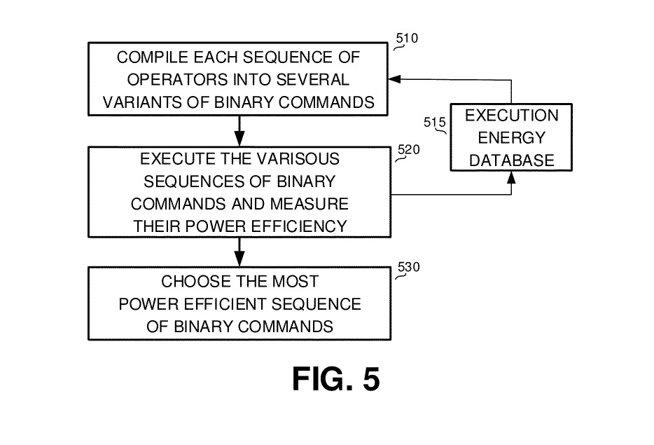

FIG. 5 is a flow chart illustrating power optimization during the compilation. Compiler optimization to maximize the speed or minimize the used memory are known in the art. Here we disclose a novel compiler optimization, aimed to minimize the energy consumed during the program execution. In step 510 the program is compiled. The compilation uses the database of execution energy 515, which stores the execution energy for binary commands, and sequences of commands.

During the compilation from high level programming language such as C, C++, Java, C# or other to the assembly language, there are multiple optional ways to compile the same high level command or high level procedure into the different sequences of low-level commands, the compiler chooses the most power efficient way, or at least takes into consideration the power efficiency, using the execution energy database 515. The compiled sequence of commands might be executed in step 520 in order to measure the energy consumption, which may be used in choosing the most power efficient version among several alternatives, and to update the execution energy database 515. The compilation process may be iterated several times. Finally in step 530 the optimal energy efficient compilation is chosen. The present disclosure is not limited to optimization solely for energy efficiency—other optimization criteria such as execution speed, memory usage etc. may also be taken into account.

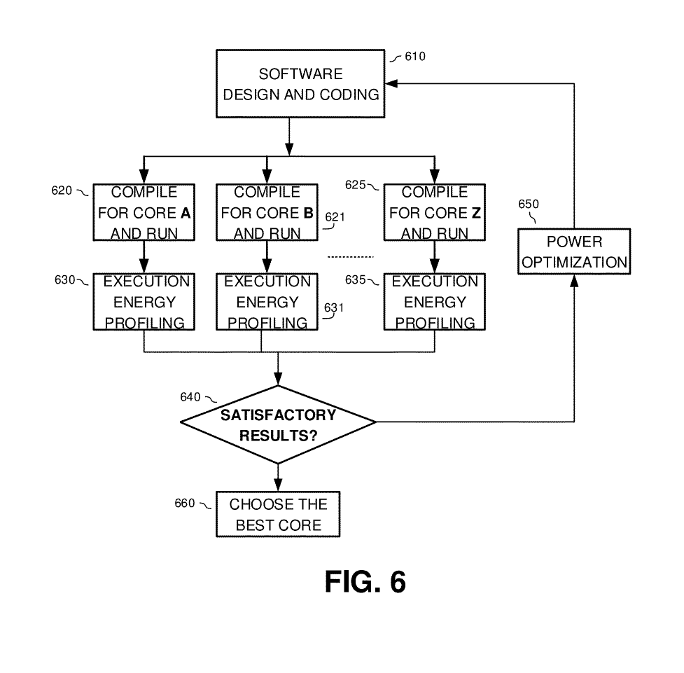

FIG. 6 is a flowchart of choosing the most appropriate computation core for software execution. It might be easy to find the core which executes the given block of software in shortest time, however the total energy consumption might be lower on another core. Step 610 designates the design and coding stage of software development. Steps 620, 621, . . . , 625 represent compilation of the software for different processing cores. Note, that if the cores vary significantly in architecture, the software design might need dedicated development for each hardware core.

In steps 630, 631, . . . , 635 the software is executed on different cores, execution energy measured, profiled and recorded for various blocks and parts of the software. Note that the software might be divided into blocks, and different blocks being executed on different computational cores.

Finally the procedure might be iterated with some re-engineering in steps 650 and 610, based on the gathered energy statistics, or the most efficient version may be chosen in step 660.

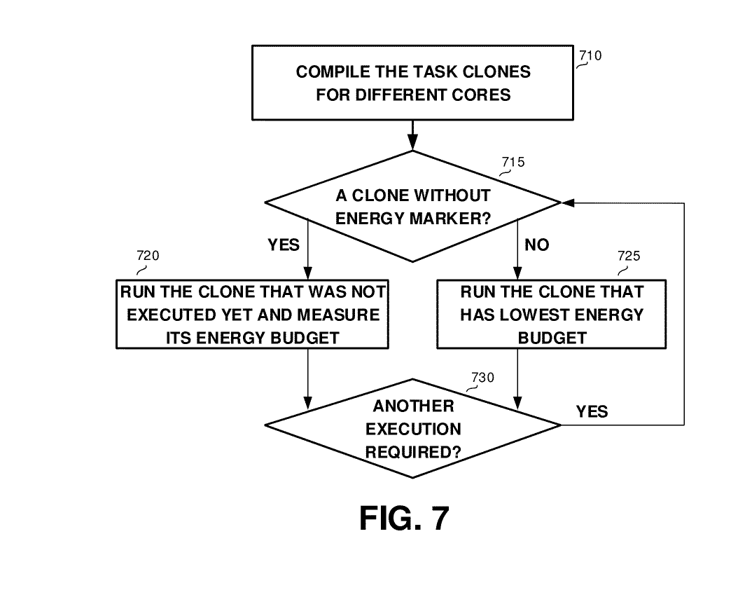

FIG. 7 is the flowchart for energy efficient software execution, using the task clones compiled for various cores. In this approach the decision about the most power efficient core is postponed from the design phase to the execution phase. This might be useful in the cases when the exact power efficiency of the cores is not known at the software development phase, or when the target architecture is not known in advance.

The software has at least one task, which is coded and compiled for at least two different computation cores. These different compilations are referred as clones of the task. An example of such clones may be some image processing operation, such as denoising, implemented and compiled for different cores, such as generic CPU, and/or vector processor and/or GPU. These clones will have different run-time, different power required for execution and different execution energy.

During the execution phase, a clone for some task is chosen and executed in steps 715, 720 and 725. It might be the clone with lowest energy mark, or the clone without energy mark, which was not yet executed and which execution energy was not measured yet. After execution of the clone its execution energy is measured and stored, and in later decision this execution energy can be considered in the decision of which task clone to load and execute.

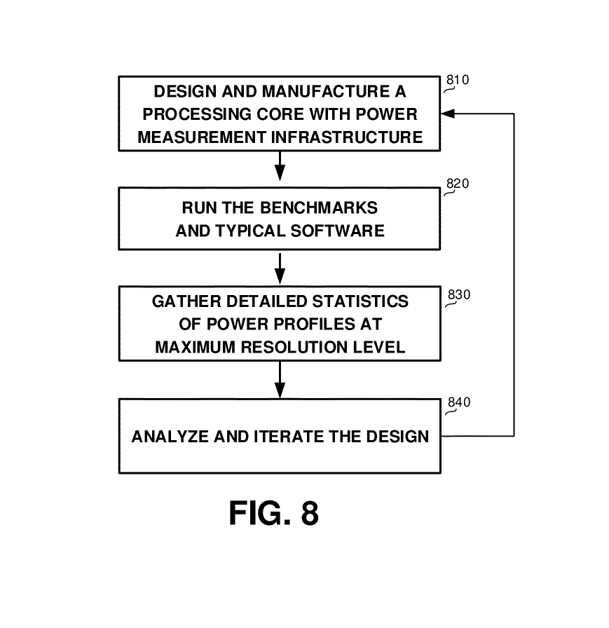

FIG. 8 is the flowchart of hardware development for power optimization. In step 810 the processing core, or hardware block is designed, including the capabilities of power measurement. In steps 820 and 830 the benchmarks of interest for a given processing core or block are executed on it, and the detailed statistics and power profiles are gathered. The statistic at fine level of resolution, regarding parts of the core or block might be gathered if applicable. In step 840 the gathered statistics is analyzed, energy burners are optimized and redesigned, allowing to design the next generation of processing core or block with better energy characteristics in step 810.

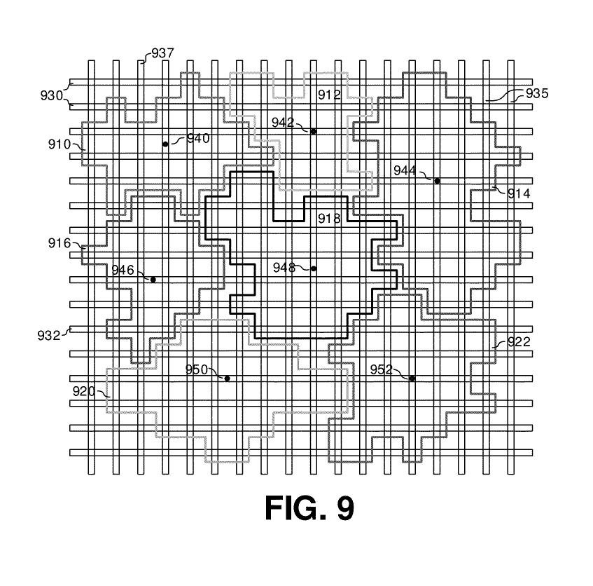

FIG. 9 schematically illustrates one of the ways to measure the power consumption by the cell. Lines 930 and other lines parallel to them, as well as 935 and other lines parallel to them illustrate the grid of Vdd and Vss lines known in the art as the power grid. The illustrated VLSI area is divided into several computational cores, 940, 942, 944, 946, 948, 950 and 960. Alternatively they may represent several functionally different blocks of the same core, or other functionally different cells of the hardware. Since the listed hardware blocks use the common power grid lines, their power consumption will jointly cause the voltage drop along the power lines. For example supply line 932 is used by blocks 916, 918, 920, 922 while supply line 937 is used by the blocks 910, 916 and 920.

In order to separate between the influences of different blocks on the voltage drops within the line, the voltage measuring circuitry is connected to the one or more representative points within the block, such as point 940 for block 910, point 942 for the block 912, point 944 for the block 914 etc. The voltage difference between the representative points of the neighbor blocks allow to estimate the power consumption of the block.

For example, to estimate the power consumption by the block 918, the voltage difference between its representative point 948 and representative points 940, 942, 944, 946, 950, 952 of the neighbor blocks 910, 912, 914, 946, 950, 952 are measured. The relationship between the voltage differences and the power consumption can be estimated by calculation, simulation, or experimental measurement and calibration.

Other method to measure the power consumption of the cell may include voltage drop measurement across multiple power lines crossing the given cell, power isolation of the cell with power switch transistors and measuring the voltage drop across some or all of the power switch transistors.

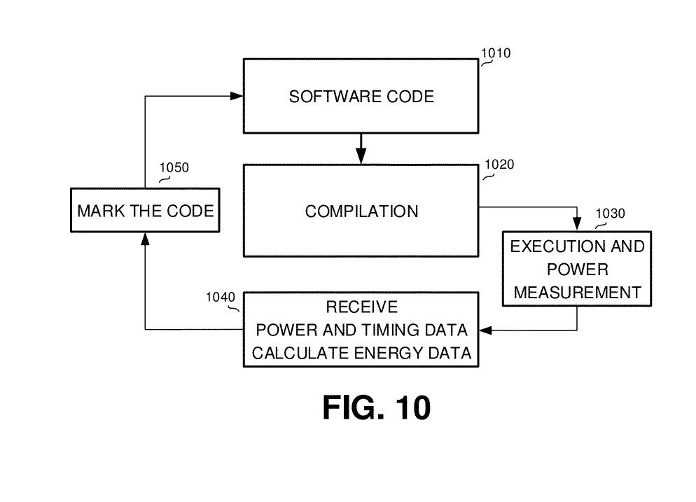

FIG. 10 schematically illustrates the energy profiling of the software during its execution on the hardware with disclosed power measurement capabilities. Block 1010 represents the software source code, which is compiled in step 1020 and loaded for execution into power-profiling enabled hardware in step 1030. In step 1030 the software is executed, and the consumed power as well as the running times for the software are measured there.

They might be measured as the total power consumed by the processing core during execution of the software module. The power profiling can be done at different levels of resolution—both within the software, in the hierarchy of profiling from the complete software module, through the isolated procedures, to the single command, or at different resolutions within the hardware—from power consumption by the whole computational core, to the consumption of isolated blocks or cells within the core. The measured power consumption data as well as the run times are sent back to the system in step 1040, where energy consumption is calculated by integration of power consumption over the runtime. The gathered and calculated data might be embedded into the software source code for further analysis in step 1050.

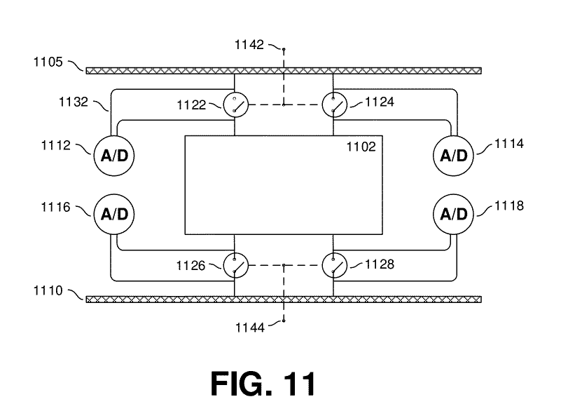

FIG. 11 illustrates the power measurement for the systems with gated power supply, where the gates 1122-1128 on the power lines allow to switch off the specific hardware block 1102. In that case measurement of the voltage drop across the power gates, 1122, 1124, 1126, 1128, and knowing resistance of power gates and the supply voltage allows evaluating the consumed power. Various configurations are possible, where the voltage drop across the power gates from only the Vdd line 1105, or Vss line 1110 or both lines are measured. 1142 and 1144 denote the controls of the power gates.

One embodiment of this disclosure comprises a digital signal processing system, which comprises a number of cores, each core comprises a number of modules, and each module comprises a number of cells. The term computational block may refer here to any level of hierarchy, namely to any processing core, or module or cell.

The un-complete list of examples of digital signal processing systems considered here includes application processors of smartphones, tablets, laptops, application processors with heterogeneous system architecture, Application Specific Integrated circuits, Multi-chip modules, systems on chip, VLSI integrated circuits, mixed signal integrated circuits etc.

The computational blocks of the system comprise the means for power measurement, which are the means for evaluation of the electric power consumed by the block during its operation. Different means for power evaluation known in the art are covered by this disclosure. The un-complete list of means for power measurement include recording and processing the oscillation frequency of the ring oscillators, measurement of the temperature and variation of supply and ground voltages, etc.

The preferred embodiment elaborates on power evaluation via monitoring the voltage drop in the power supply lines. That voltage drop is due to the resistance of the lines, and supply current flow, and is often referred in the industry as IR drop. The IR drop is developed in both power and ground supply lines, and can be monitored on either of both of them. Both power and ground supply lines will be referred as power supply lines, supply lines or power lines. The terms voltage drop and IR drop will be used interchangeably.

In present art architecture, the power lines form a power grid, and each block of the system usually receives its power and ground supply from multiple supply lines. Furthermore, the same power line usually supplies several blocks, which it crosses. One of the ways for accurate evaluation of the power consumed by a given block is to measure the voltage drop across all the power lines that supply it, and to measure that drop from on the sections of the power lines between the given block and the neighbor block.

The Current is evaluated from known, calculated, calibrated or simulated resistance of the power lines R, and the voltage drop dV, namely I*R=dV→I=dV/R, where dV is the voltage drop, I is the current, R is the line resistance over the monitored section. The consumed power P is calculated as P=Vdd*I=Vdd*dV/R. The power supplied to the block is the sum of powers supplied through all the individual power lines. In another approach not all the power supply lines leading to a given block are monitored, but only one or several representative power lines.

The power consumption of the block can be evaluated from the voltage drops along the representative sections of the representative lines. The relation between the voltage drop in the representative power lines to the power consumed by the block can be obtained by calculations, simulations or measurements, as it is known to engineers skilled in the art. The power lines may embed the power gating transistors, in which case the voltage drop across the gating transistor or across section of power line including the gating transistor can be monitored.

In the preferred embodiment, the voltage drop is monitored with Analog to Digital Converter (ADC). The sampling rate of the ADC may vary from 10̂3 to 10̂12 samples per second, or higher for the next generations, and the voltage range may vary from millivolts to tens of volts, the number of resolution bits from 1 to 24. However, in the preferred embodiment the sampling rate varies from 10̂5 to the clock-rate of the monitored block, the voltage range from the order expected IR drop to the Vdd or supply voltage of the monitored block, and the number of resolution bits from 10 to 16.

The consumed power varies in time, depending on several factors, including the software executed by the block, and therefore it can change significantly during short duration of the time, up to significant change during period of the single system clock. The energy consumed by a block during a certain period of time, or during execution of a certain software task is evaluated as an integral of consumed power over time.

Due to variability of power in time, the voltage drop is monitored periodically. Furthermore, a low pass integration filter, such as RC, LR filter or filter of any other architecture, may be used to smooth the voltage variations, with time integration corresponding to or exceeding the period between consecutive voltage drop samplings.

In order to increase number of monitored blocks, and decrease relative number ADC's on the circuit, a switching circuitry may be used. Each ADC can monitor multiple sections of power lines, corresponding to the same or different computational blocks. The switching circuitry can be controlled by a dedicated control register, or by several bits within the ADC control register. Power monitoring at multiple levels of hierarchy can be facilitated, allowing monitoring of the power and evaluating of execution energy of processing cores, its modules, and cells.

The hardware described above executes the software. The software can be divided in several types of functionality, such as operating system, and applications, user interface, image, video, graphic, audio processing etc. Different parts of the software may require execution on different parts of the hardware. Here, without loss of generality, we consider the software being divided into tasks. Furthermore, we consider a particular software task being executed on particular hardware block.

The ‘task and block’ can vary from operating system, executed on general purpose processing core, to single pixel of the particular video frame, being bit-shifted in the single cell of the vector processor. The power consumed by hardware block for execution of the software task is monitored, and the execution energy is evaluated, as the integral of the power over execution time.

That power and energy monitoring of software execution allows multiple novel methods that improve energy efficiency of hardware and software.

Software energy profiling, where each task of the code receives one or several energy tags. After execution of that particular part, function, task or command, and measurement of its execution energy, the value of execution energy is communicated back to the software source files or development environment. That software profiling allows to localize and improve the ‘energy burners’ critical parts of the software, to choose the best energy saving algorithm, to choose a most appropriate hardware block for execution of a particular software task, to analyze the energy efficiency of software and hardware. Some of the tasks can be programmed and compiled for execution on different hardware blocks. Software energy profiling allows to find the most efficient binding between software tasks and hardware blocks.

Energy optimization at compilation. There are more than one way to compile the software from high level language into binary code. There are known techniques of optimization at compilation, when the compiler can produce a code optimized for execution speed or for memory footprint. Similarly, software energy profiling allows to produce code optimized for execution energy. For that, the compiler creates, updates and/or uses the database, describing the energy budget for execution of particular commands or sequences of commands on each of the hardware blocks. Such database allows compiler to choose the most energy efficient compilations corresponding to software tasks coded in high level programming language.

Energy optimization at execution. The same software task can often be coded and compiled for execution on different hardware blocks. These different implementations and compilations of the same task for execution on the different hardware blocks will be called ‘clones’. Sometimes it can be unknown at the development phase which block is the most appropriate for execution. In that case, during the execution of particular clone of that task its execution energy is measured and stored (the clone is ‘energy tagged’). During the next execution of the task, its clone with lowest energy tag, or the clone that was not executed yet will be selected. The particular algorithm for clone loading, tagging and selection may vary. For example, for each execution the next untagged clone is loaded, and after all clones are tagged, the clone with lowest energy tag is selected.

Energy optimization at updates. At the development phase for remote environments, such as smartphones, it is hard for the developer to foresee the most energy efficient solutions due to unknown statistics on the hardware. However gathering and sending back the execution statistics including the energy profiling in the user environment allows to improve the software and distribute more energy efficient update to the users.

Hardware profiling and optimization. Energy profiling of software and hardware allows to localize the most energy efficient hardware blocks, as well as localize and improve the ‘energy burners’, which allows the development of energy efficient and energy optimized hardware in the next generation.

Power measurement unit (PMU) is the processing and controlling unit of the digital system, which controls the clock-rates and/or the voltages of the processing blocks. Higher clock-rates reduce the execution time, but often require higher supply voltages and result in higher power and even energy of task execution. The algorithms of operation of PMU within the framework of the present disclosure can depend of the execution energy. For example, for the tasks with low energy of execution but strict time requirement, the clock-rate of executing block can be accelerated. Contrarily, for the energy-hungry tasks, with significant execution energy, the clock-rate of executing block may be reduced by the PMU.

What is claimed is:

1. A digital signal processing system, comprising a multitude of computational blocks, and a means for measurement of the power consumed by at least one of the said blocks.

2. A digital signal processing system of claim 1, where the said means for power measurement is based on measurement of voltage drop in one or more of power or ground supply lines.

3. A digital signal processing system of claim 2, where the said voltage drop is measured by analog to digital converter (ADC).

4. A digital signal processing system of claim 3, further comprising at least one switch, allowing to switch the ADC measurement between at least two different regions.

5. A digital signal processing system of claim 4, further comprising a low pass filter averaging in time the voltage drop fluctuations.

6. A digital signal processing system of claim 5, further comprising a configuration register that controls at least switching of ADC between different regions.

7. A digital signal processing system of claim 3, further comprising a value register, storing the digitized value of the voltage drop.

8. A method of software profiling for a digital processing system comprising a multitude of computational blocks with means for power measurement and running a software comprising a number of tasks, where the energy of execution of at least some of the tasks is evaluated as integral of power over time, and stored.

9. A method of software profiling of claim 8, where at least some of the tasks are executed and profiled in at least two different versions.

10. A method of software profiling of claim 8, where at least some of the tasks are executed and profiled on at least two different computational blocks.

11. A method of software optimization, where the results of software profiling as in claim 8 are used to improve the energy efficiency of software execution.

12. A method of energy optimization in software development, using software profiling of claim 8, in order to select the most efficient implementation versions.

13. A method of energy optimization in software compilation, using software profiling of claim 8, in order to select the most efficient compilation versions.

14. A method of energy optimization in software execution, using software profiling of claim 8, where at least some of software tasks are developed and compiled in at least two versions for execution on at least two different hardware blocks, and the execution energy is evaluated, and considered in selection of version for loading in execution.

15. A method of software updating, using software profiling of claim 8, to collect statistics on energy of execution of the software running on different hardware versions for further software development and update.

16. A method of development of digital systems comprising a number of processing blocks with means for power measurement, where the benchmark software comprising a number of software tasks is compiled for execution on alternative processing blocks, and the execution energy of software tasks on processing blocks is evaluated, and accounted in selection and modifying the hardware blocks in design of next version of digital system.

17. A method of power measurement for the digital signal processing system of claim 1, where the energy of execution of software tasks on processing blocks is measured, and the clock-rates of the said blocks are adjusted in accordance with the said execution energy.
